(19) United States
(12) Patent Application Publication
(10) Pub. No.: US 2011/0098862 A1
(43) Pub. Date: Apr. 28, 2011

(54) Multi-stage processes and control thereof

(75) Inventors: Marco A. Andrei, Fairfax, VA (US); Apostolos T. Georgiou, Reston, VA (US)

(73) Assignee: ExxonMobil Research Engineering Company Law Department, Annandale, NJ (US)

(21) Appl. No.: 12/588,748

(22) Filed: Oct. 27, 2009

(51) Int. Cl. G05B 21/00

(52) U.S. Cl. 700/272

(57) ABSTRACT

A method is provided for controlling a multi-stage process. The process comprises multiple first stage processes for producing an intermediate product from a feed, and multiple further stage processes for producing an end-product from the intermediate products. The first stage processes comprise multiple intermediate processes and the further stage processes comprise multiple end processes for producing the end product. An intermediate controller controls the first stage processes in response to one or more product properties of the end product EP and a further controller FC controls the further stage processes in response to the product properties of the intermediate product. The multi-stage process further comprises the step of assigning process values to each of the end processes and the intermediate processes. The intermediate controller IC controls operation of the intermediate processes to optimize the overall process value for producing the end product. The end controller FC responds to the actions of intermediate controller IC to optimize the overall process value.

### 1.0 BACKGROUND OF THE INVENTION

1.1 Field

The present invention relates to a method of controlling a multi-stage process. More particularly, but not exclusively, the present invention relates to a real time method for controlling a multi-stage process, a control apparatus and a program storage device there for.

1.2 Description of Related Art

Real time optimization (RTO) apparatus or systems provide on-line process control of plant processes to ensure that these processes run close to their economic optimum. Conventionally, RTO systems consist of rigorous non-linear models which process data in real time to optimize an objective function of the process parameters in order to control the process at the conditions which provide most economic benefit. Typically, these RTO systems operate every few minutes to every few hours to determine the optimized process control parameters.

RTO systems are conventionally applied to each separate process and they operate independently. In the calculation of the optimized operational parameters, they sometimes receive pricing data of feed streams and of the end products. Prices of intermediate products are not taken into account or, if these are taken into account, these prices are estimated offline and entered infrequently, typically weekly or monthly.

Consequently, current real time optimization systems are often inaccurate and inadequately adapted to follow market pricing structures at short notice. As a result, conventional RTO controlled multi-stage processes are only occasionally operating at optimized operating conditions. This causes inefficient production, and inefficient use of feedstock, intermediates and energy. These inefficiencies in turn affect the economic performance of the overall process.

The present invention aims to obviate or at least mitigate the above described disadvantages and/or to provide technical benefits and/or improvements generally.

### 2.0 BRIEF DESCRIPTION OF THE SEVERAL VIEWS OF THE DRAWINGS

FIG. 1 provides a diagrammatic view of a process according to an embodiment of the invention.

FIG. 2 provides a diagrammatic view of another process according to another embodiment of the invention.

FIG. 3 provides a diagrammatic view of a further process according to yet another embodiment of the invention.

### 3.0 SUMMARY OF THE INVENTION

According to the invention, there is provided a method, an apparatus, and a program storage device as defined in any one of the accompanying claims.

In an embodiment there is provided a method of controlling a multi-stage process, the process comprising:
a) providing one or more first stage processes for producing an intermediate product IP from a feed F, wherein the first stage processes comprise multiple intermediate processes I_{1 . . . n} for producing the intermediate product IP;
b) providing one or more further stage processes for producing an end-product EP from the intermediate product IP, wherein the further stage processes comprise multiple end processes E_{1 . . . n} for producing the end product EP;
e) providing an intermediate controller IC for controlling the first stage processes in response to one or more product properties of said end product EP;
f) providing a further controller FC for controlling the further stage processes in response to the product properties of the intermediate product IP;
g) assigning process values VE_{1 . . . n} to each of the end processes E_{1 . . . n} and process values VI_{1 . . . n} to each of the intermediate processes I_{1 . . . n}; and
h) controlling, with the intermediate controller IC, operation of the intermediate processes Iᵢ with i=1 . . . n to optimize the overall process value VE for producing the end product EP.
   In this way, as the intermediate process is effectively controlled based on the properties of the end product, and the further stage process is controlled by the properties of the intermediate product, control of the product is dependent both on performance of the intermediate process and on the further stage process. This allows the overall, multi-stage process to be optimized based on the performance of individual intermediate processes and end processes which results in an overall, more efficient multi-stage process.

The process values may be derived from process parameters such as process running time, process operation costs and/or combinations thereof. The process values may also be derived from the feed properties, intermediate feed properties, end product properties, feed costs, end or intermediate product costs, shadow prices and/or combinations of the aforesaid properties.

The overall process value may be calculated as the sum of the process values. The overall process value depends on the selection of the intermediate and end processes which are operated and the selected operating parameters (flow rates, operating conditions, etc.) for the selected processes. The process value further depends on the properties of the intermediate and/or end product. These properties may comprise physical properties (such as temperature, viscosity, quality, etc.) and economic properties (such as economic value including cost, pricing etc.).

The overall process value may be optimized by defining an objective function for the overall process value and optimizing this function. The process values VE_{1 . . . n} and VI_{1 . . . n} may be derived by suitable models as outlined in this application.

In an embodiment, there is provided a real time optimization system adapted to perform the method of this invention.

In a further embodiment there is provided an apparatus for controlling a multi-stage process for producing an end product EP. The multi-stage process comprises i) one or more first stage processes for producing an intermediate product IP from a feed F, wherein the first stage processes comprises multiple intermediate processes I_{1 . . . n} for producing the intermediate product IP and ii) one or more further stage processes for producing an end-product EP from the intermediate product IP, wherein the further stage processes comprise multiple end processes E_{1 . . . n} for producing the end product EP. The apparatus comprises the following components: (a) an intermediate controller IC for controlling the first stage process in response to one or more product properties of said end product EP; (b) a further controller FC for controlling the further stage process in response to the product properties of the intermediate product IP; and (c) a means for assigning process values VE_{1 . . . n} to each of the processes E_{1 . . . n} and process values VI_{1 . . . n} to each of the intermediate processes I_{1 . . . n}. The intermediate controller IC is adapted to control the intermediate processes I_{1 . . . n} to optimize the overall process value derived from process values for the intermediate product VI_{1 . . . n} and the end product EI_{1 . . . n} to produce the end product.

In another embodiment there is provided a program implemented on a data carrier, and a computer adapted to conduct a method as herein before described.

Finally, there is provided a method for controlling a multi-stage process that comprises: a first stage process for producing a first stage product from a first stage feed stream; a further stage process for producing a further stage product from the first stage product as a feed; providing a first controller for controlling the first process in response to the product properties of the further stage product; and providing a further controller for controlling the further process in response to the product properties of the first stage product.

These and other features of the invention are set forth in more detail below.

### 4.0 DETAILED DESCRIPTION OF THE INVENTION

Particular embodiments of the invention will now be described by way of example and with reference to the accompanying figures.

### 4.1 Definitions

Unless expressly defined otherwise, all technical and scientific terms used herein have the meaning commonly understood by those of ordinary skill in the art. The following words and phrases have the following meanings as set out below.

“Application” or “application program” means a computer program, or collection of computer programs, that performs a stated function not related to the computer itself, stored on a tangible computer readable medium.

“Model” embraces a single model or a construct of multiple component models.

“Lumping” is a process by which data on the molecular population of a stream is substantially reduced (“lumped”) by an application to a more manageable form by grouping the data into groups called lumps. Conversely, “de-lumping” is a process where lumped data is expanded again (“de-lumped”), usually by reversing the operations performed by the original lumping algorithm.

“Objective function” or “cost function” are typically defined for model tuning and economic optimization problems. For model tuning, “objective function” or “cost function” refers to a mathematical function that indicates the degree of agreement or disagreement between predicted characteristics of a tentative process-based model and the desired characteristics of a model from known data. The function is commonly defined so as to attain a value of zero for perfect agreement and a positive value for non-agreement, and the optimization drives the value towards zero. For economic optimization, the “objective function” typically consists of a profit calculation whereby the difference is calculated by product realizations minus feed costs and minus operating costs, and where the optimization maximizes profit.

“On-line” means in communication with a process control system. For example, refinery model variables tuned on-line are typically tuned automatically with refinery data pulled from a refinery process control system. In contrast, refinery model variables tuned off-line are typically tuned with manually input data from other sources (e.g., a plant data historian and/or laboratory data).

“Process unit” means any device in a crude oil refinery or chemical manufacturing plant that treats a feed stream to generate a product stream having a different chemical composition. For example, “process unit” embraces atmospheric distillation units, vacuum distillation units, naphtha hydrotreater units, catalytic reformer units, distillate hydrotreater units, fluid catalytic cracking units, hydrocracker units, alkylation units, and isomerization units.

“Processor” means a central processing unit, a single processing unit, or a collection of processing units in communication with one another that work with data and run a given application.

“Real-time” means instantaneous or up to four hours or less, preferably up to 2 hours or less and more preferably up to 1 hour or less, up to 30 minutes or less, or up to 5 minutes or less.

“Real-time optimization application” or “RTO application” or “RTO” means an application that determines, in real-time, optimized set points for a process unit by maximizing certain results and minimizing certain results using a model that mimics the process performed by the process unit.

“Process value” is value of a process based on its operational cost. The process value depends on the selection of the process for producing a product and its operational cost. This in turn depends on the selected operating parameters (flow rates, operating conditions, etc.) for the selected processes and on the properties of the product. These properties may comprise physical properties (such as temperature, viscosity, quality, etc.) and economic properties (such as “economic value” including cost, pricing etc.).

“Economic value” is value of a product or process based on its cost or ability to generate income. The economic value may be derived from pricing information, product properties, quantity of product, quality of product and/or a combination of the aforesaid parameters.

“Overall economic value” is the sum of economic values.

“Shadow Price” for a fixed or constrained model variable means the amount that the RTO profit objective function would change if the variable is increased by one unit.

“Stream” means any fluid in a refinery flowing to or from a process unit. For example, “stream” includes crude oil as well as liquefied pertrol gas (LPG), light straight run naphta (LSR), heavy straight run naphta (HSR), kerosene, diesel, vacuum gas oil and vacuum residue and precursors thereof “Intermediate Stream” refers specifically to a stream produced by one process unit and routed to another for the purpose of further elaboration into a “finished product”, meaning that it is suitable for sale at a specified market price.

“Upstream” means in the opposite direction of the flow of the stream. Conversely, “downstream” means in the direction as the flow of the stream. In a multi-stage process, the “intermediate stage processes” would generally occur upstream from the “further stage processes” which are downstream from the intermediate stages.

“Intermediate product” means a product which is produced in an upstream stage of the particular process which is not the last stage of the process. “End product” means a product which is produced a further stage process of a particular multi-stage process which occurs after the intermediate stage process.

### 4.2 Description

Conventionally, controllers in the form of real-time optimizers (RTOs) are used to control processing units, such as pipe stills, reformers, FCCU, energy systems, etc. The individual RTOs are often controlled by a real time optimization system, which runs on an on-line process control computer and which automatically calculates and implements the optimization results. The system aims to keep each phase of the plant operation close to the economic optimum.

The current practice is for manufacturing planners to provide off-line estimations for intermediate stream prices, which are updated weekly or monthly. Often, a single price valuation is given for the whole stream, which is independent of the stream's actual quality, and therefore frequently inaccurate. Sometimes, an additional quality-based price modifier is provided to adjust the stream's price according to a resulting key quality. Due to the low frequency of price updates, and due to their low economic information content regarding quality or molecular composition effects, these intermediate stream pricing schemes provide limited economic guidance to the RTO systems. As a result, an individually acting RTO system will tend to push “its” unit towards a local optimum point, rather than an integrated approach whereby all RTOs are integrated to achieve a global, plant-wide optimum operation.

Conventional RTO systems are incapable of controlling multi-stage processes comprising multiple intermediate products serving as feed to subsequent processes and producing one or more end products so that the overall integrated process operates to an economic optimum, taking into account economic factors such as real time feedstock, intermediate and end product prices, energy and waste sourcing and pricing levels connected therewith in real time.

The invention provides optimized performance of a multi-stage process by ensuring that the selected processes are operated at selected operating conditions to ensure optimized performance of the overall multistage process. The multi-stage process may consist of an entire manufacturing complex (such as a refinery or chemical plant). The method of the invention ensures optimized operation of this process in real time as it operates the process at or close to the economic optimum. More particularly, the method of the invention provides the calculation of real-time prices for intermediate stream compositional species or qualities, working back from the blending of finished products, in order to drive multiple intermediate and further controllers towards a consistent plant-wide optimum operation.

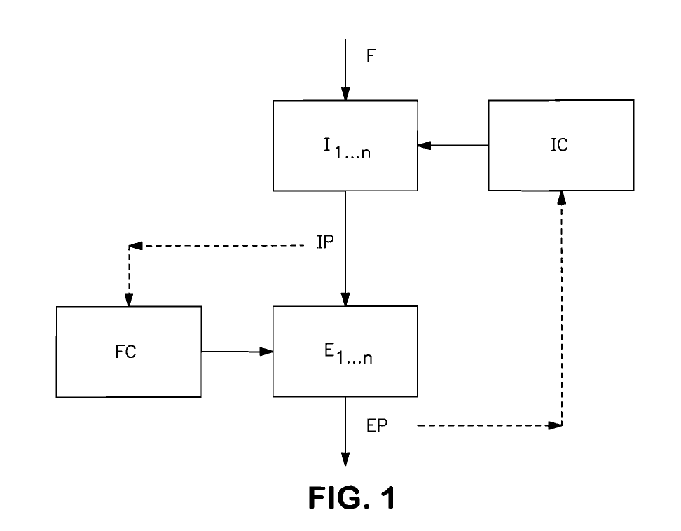

In an embodiment, there is provided a method for controlling a multi-stage process as shown in FIG. 1. The process comprises a first stage process for producing one or more intermediate products IP from feeds F, and a further stage process for producing further products or end products EP from the intermediate product IP; wherein the first stage process comprises multiple intermediate processes I_{1 . . . n} for producing the intermediate products IP and the further stage process comprises multiple end processes E_{1 . . . n} for producing end products EP. The process further includes an intermediate controller IC for controlling the first stage process in response to one or more product properties of the end products EP and a further controller FC for controlling the further stage process in response to the product properties of the intermediate products IP.

As the intermediate stage is effectively controlled by taking into account the properties of the end product, and the further stage process for producing the end product is controlled taking into account the properties of the intermediate product of the first stage, an integrated, or coupled, control of the process is provided which allows the multi-stage process to be controlled close to its overall optimum. In contrast, in conventional real time optimization systems, each stage is independently controlled to its optimum for each stage without taking into account the overall optimum of the integrated multi-stage process.

In this way, an integrated method of controlling the multi-stage process is achieved as both the intermediate controller and the further controller use properties of the respective end product and intermediate product to control their respective intermediate and further stage processes. In addition, it is possible to provide additional control input which may not be directly dependent on product properties, but which may relate to product properties nonetheless. Such information may comprise economic information about the end product and intermediate products such as price, in the form of spot price or futures price, availability, batch information and product specifications.

In another embodiment, each of the intermediate process I_{1 . . . n} are adapted to produce the same intermediate product IP. This may also apply to each of the end process E_{1 . . . n}. Multiple intermediate or further processes are thus available to produce the intermediate product and/or end product. The controllers select the optimized path or route for producing the end product by selecting the best intermediate and/or end processes for producing the end product.

This is achieved in the following way. The process may comprise the step of assigning process values VE_{1 . . . n} to each of the processes E_{1 . . . n} and process values VI_{1 . . . n} to each of the intermediate processes I_{1 . . . n}. The intermediate controller controls the intermediate processes Iᵢ to optimize the overall process value derived form process values for the intermediate product VI_{1 . . . n} and the end product E_{1 . . . n} to produce the end product. The further controller controls the end processes Eᵢ to optimize the overall process value to produce the end product. In this way the multi-stage process is controlled to produce the end product. The overall process values are optimized by defining an objective function for the overall process value and optimizing said function, the controllers controlling the respective processes E_{1 . . . n} and E_{1 . . . n} in response to the optimized objective function. The objective function may comprise properties of both the intermediate product and of the end product. Properties may comprise product composition, quantity, price and physical properties such as density, flow rate, viscosity, temperature, and concentration and/or combinations thereof.

In another embodiment of the invention, the intermediate controller activates one or more intermediate processes EI. To meet the optimized objective function, the intermediate controller activates one or more intermediate processes EI which allow the overall, multi-stage process to perform at its optimum.

The further controller may also activate one or more downstream processes E_{1 . . . n}. Again this is in response to the calculation of the optimized objective function for which the overall process operates at its optimum. The process values for the intermediate product and end product may be derived from feed and/or end product properties, the feed and/or end product properties comprising product composition, quantity, price and physical properties such as density, flow rate, viscosity, temperature, and concentration and/or combinations thereof

The process values VE_{1 . . . n} and VI_{1 . . . n} are derived by a model comprising a quality blending model, a quality barrel model, a component lumper model, a component delumper model, a compositional pricing model, an intermediate stream source model, a mixer model, an analyzer model, a compositional blending model, a total feed source model and/or combinations of the aforesaid models. These models are discussed in further detail below.

The process values may be derived from shadow prices, the objective function being derived from the shadow prices. Shadow prices are discussed in further detail in the section below. The process values VI_{1 . . . n} are derived from the process values VE_{1 . . . n}. Conversely, the process values VE_{1 . . . n} are derived from the process values VI_{1 . . . n}.

In a preferred embodiment, the process is controlled in real time. This allows the process to be controlled in relation to real time market prices or spot prices. The process may further comprise the step of predicting product properties, and product price in particular, by means of a predictive model. The process may be controlled in relation to the predictive model. Alternatively, the product properties may be predicted by means of a predictive model. According to another invention there is provided a process implemented on a data carrier or computer adapted to conduct the method as hereinbefore described.

The process of the invention may be implemented in existing real time optimization (RTO) application program components which enable each RTO controller to calculate and communicate, in real time, the economic value of feed streams, intermediate product streams and end product streams. The steps of controlling a first stage process in response to one or more product properties of said end product EP and controlling a further stage process in response to the product properties of the intermediate product IP optimize the overall economic value derived from economic values for the intermediate product and the end product.

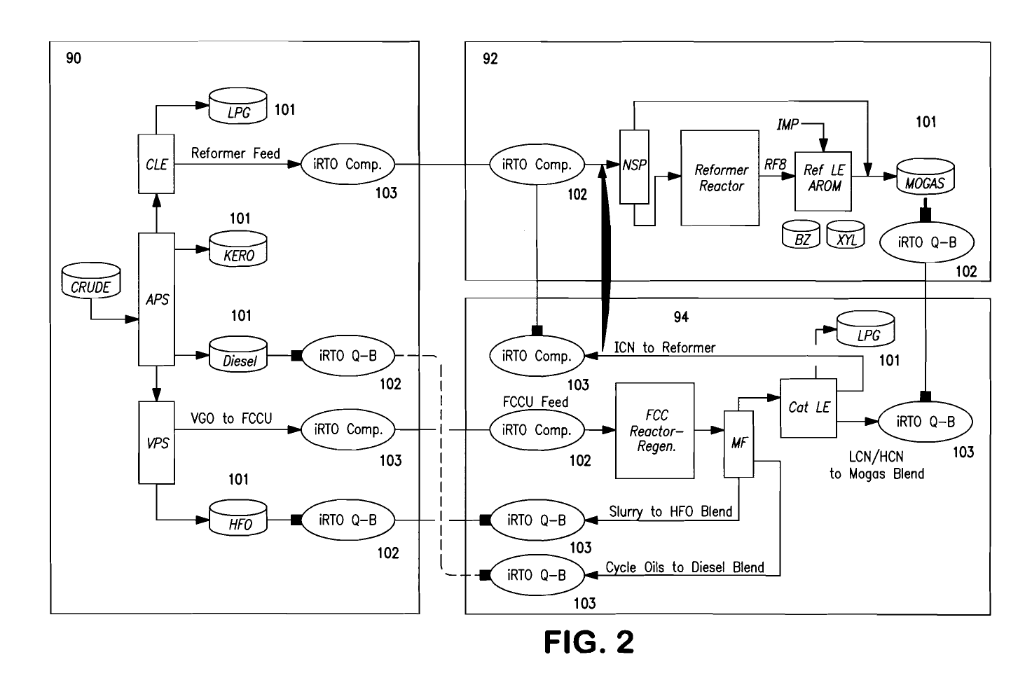

FIG. 2 shows a typical implementation of the process of the invention by integration of existing, independent RTO applications. Existing RTO applications in this example are modified to contain additional supporting modules so that the RTO controllers can perform the functions in accordance with the invention.

The process produces a number of products 101: motor gasoline (MOGAS), benzene, xylene, kerosene, diesel, HFO (heavy fuel oil) and LPG (liquefied petrol gas) from crude oil. The process comprises a crude distillation stage 90, a reformer stage 92 and a fluidized catalytic cracking (FCC) stage 94. Intermediate product from the distillation stage 90 is fed to the reformer stage 92 and the FCC stage 94. Controllers in the form of real time optimization modules 102, 103 control the various processes.

The functionality of these modules 102, 103 varies. This depends on whether the process units of each stage 90, 92, 94 optimized by each controller create, or process as feed, one or more intermediate streams, and whether they also produce one or more finished blended products. For every intermediate stream that is a feed to a downstream process unit, a set of models is added to the corresponding controller module 102 which calculates in real-time the value, or Shadow Price, of each molecular or compositional species to that process unit. For the upstream units producing the same intermediate streams, models are added which convert the compositional values into economic values which in turn are used to define and optimize the objective functions of the corresponding modules 103. Where intermediate streams are sent directly to finished product blending, the valuation and pricing can also be conducted at a compositional level, or it can be conducted by calculating the economic quality-barrel effect which the stream has on the product blend.

In order for the compositional and quality-barrel valuation and pricing to be accurate at all times, it must reflect current operating conditions and stream compositions across the manufacturing complex. The compositional and quality-barrel Shadow Prices as calculated for the intermediate feed streams are based on the composition of each stream, as input to the downstream controller. As the upstream controller executes each new optimization cycle, the quantity and composition of the intermediate feed streams changes, and the Shadow Prices of these streams as valued by the downstream controllers will also change. To continuously track this dependency of Shadow Prices on feed composition, the upstream controllers communicate, after each optimization cycle, the latest predicted stream qualities to the downstream controllers. This results in eventual convergence of all controllers to a plant wide optimum.

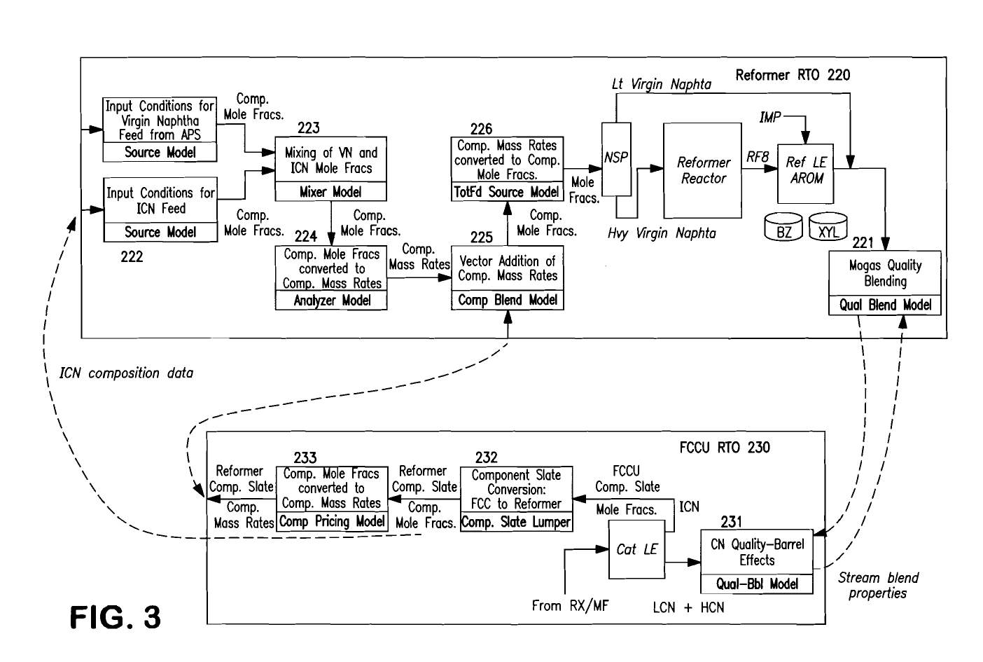

FIG. 3 illustrates the integration of two RTO controllers 220, 230 for a reformer and a FCC unit. The reformer controller comprises a number of models consisting of a source model 222, a mixer model 223, an analyzer model 224, a total feed source model 226, a composition blend model 225 and a quality blend model 221. These models are discussed in further detail below. They calculate the properties of the various intermediate and end product streams based on the properties of feed streams and other intermediate and product streams as indicated by the dotted lines in the Figure.

Preferably, all the existing RTO applications are constructed using open form, non-linear equation-based modeling software and methods that support the use of multiple solution modes with multiple objective functions (e.g., data reconciliation which adjusts variables based on actual plant data and an economic optimization mode). Suitable examples of commercially available software and methods include DMO which is a modeling platform available from Aspen Technology, Inc. and ROMeo® (Rigorous On-line Modeling with equation-based optimization) which is a modeling platform available from Invensys SimSci-Esscor. Preferably, the models comprising each RTO application are constructed using ROMeo models and methods. These systems already have code based on underlying equations which are suitable, or may easily be configured for modeling many of the process unit operations (e.g., distillation columns, mixers/flashes, splitters, valves, compressors,). However, for the more complex components of a process unit (e.g. reactors,), models are custom built to complement the suite of models available in commercial modeling systems.

The modules that are added to existing RTO applications may be implemented on conventional commercial modeling platforms. The modules incorporating the controllers may also be formed from generic calculation blocks. These blocks are provided by the modeling platforms which allow coding of underlying equations to provide the desired functionality, as described below. These modules may also be incorporated in existing RTO controllers.

The various models which are used to assign process values to the products are discussed in further detail below.

Quality Blending Model

The quality blending model calculates the inspection properties of a finished blend which are a result of the weighted quality contributions of each blend component flowing into the finished product pool. The properties that are calculated by the Blend Model are typically for the critical quality specifications which must be met by each type of finished product, as required by industry standards or by a specific sales contract. For every applicable quality “j” the following generalized blending equation is added to the Blending Model:

$${\sum }_{i = 1}^{N} F ( i ) * q ( i , j ) * φ ( i , j ) + {\sum }_{k = 1}^{M} F ( k ) * q ( k , j ) * φ ( k , j ) = Q ( j ) * [ {\sum }_{i = 1}^{N} F ( i ) * φ ( i , j ) + {\sum }_{k = 1}^{M} F ( k ) * φ ( k , j ) ]$$

where “F(i)” are the flow rates of the “i” intermediate streams numbered 1 to N which are routed to finished product blending from process units that are in the scope of the given RTO application, and “q(i,j)” is the “j^{th}” quality of the “i^{th}” such stream; “F(k)” are the flow rates of the “k” intermediate streams numbered 1 to M which are routed to finished product blending from process units outside the scope of the given RTO application (e.g. in the scope of other RTO applications), and “q(k, j)” is the “j^{th}” quality of the “k^{th}” such stream; and “Q(j)” is the “j^{th}” quality calculated for the finished product pool. Depending on the quality blended, and consistent with the blending rules generally used in industry, units of measure of flow rates “F(i)” and “F(k)” will be either on a volumetric or mass basis (e.g. volume/time or mass/time). Similarly, the blend factor “φ(i, j)” for a given stream and quality will attain a value of unity if the blend rules call for a mass or volume blending basis only, or its value will be determined by the appropriate correlation if the blend rule is to be done on a “factor” basis.

The intermediate stream flow rates “F(i)” and their qualities “q(i,j)” are within the optimization scope of the given RTO application, and will therefore vary as a function of its optimization moves. Conversely, the intermediate stream flow rates “F(k)” and their qualities “q(k,j)” are outside the scope of the given RTO application, and therefore will be unaffected by the optimization moves of the given RTO application. In the Blending Model, these latter variables are defined as independent variables with fixed values and, as part of the RTO integration mechanism, their values (e.g. flow rates and qualities) will be updated by other “upstream” RTO applications whenever they complete their optimization cycle. In order to enable the given RTO application to calculate, and then communicate to other “upstream” RTOs, the marginal economic value of the “quality-barrel” (quality*flow) effect of each “external” stream on the finished product blending, an additional variable “A(k,j)” is added to the blending equation as follows:

$${\sum }_{i = 1}^{N} F ( i ) * q ( i , j ) * φ ( i , j ) + {\sum }_{k = 1}^{M} [ F ( k ) * q ( k , j ) + Aqb ( k , j ) ] * φ ( k , j ) = Q ( j ) * [ {\sum }_{i = 1}^{N} F ( i ) * φ ( i , j ) + {\sum }_{k = 1}^{M} F ( k ) * φ ( k , j ) ]$$

Variable “A_{qb}(k,j)” in this equation represents an independent quality-barrel adjustment term for every “external” intermediate stream flow rate “F(k)” and its quality “q(k,j)”. The value of each “A(k,j)” in the product blending model is set equal to zero such that it does not influence the result of the blending calculation. However, because each “A(k,j)” is an independent variable, a Shadow Price “Δ P^{Q}_{SP}(k,j)” is generated for it during every economic optimization cycle of the given RTO application. This Shadow Price represents the incremental credit or debit for each “quality-barrel” of the respective stream added to the blend pool, in dimensions of (currency/time)/[quality*(volume/time, or mass/time)]. Similarly, since all “external” streams “F(k)” are also independent variables, a Shadow Price “Δ P^{F}_{SP}(k,j)” is generated for them as well, in dimensions of (currency/time)/(volume/time, or mass/time).

The Shadow Prices for all “F(k)” and “A(k,j)” determined in this manner are subsequently communicated to the “upstream” RTO applications implemented in the intermediate or upstream controllers which optimize the flow rates and qualities of these intermediate streams. Thus, the economic objective functions of the “upstream” RTOs are formulated to directly include, as an economic drive, the Shadow Prices for said flow rates and qualities. Similarly, the economic objective function of every “downstream” RTO application which includes one or more finished product Blending Models is also modified, to effect a systematic and consistent communication of the Shadow Prices between “downstream” and “upstream” RTOs. The following modifications are made to the objective function of the “downstream” RTOs. Modifications required for “upstream” RTOs are described in the next section (Quality-Barrel Model).

The following is an example of a Profit objective function that is maximized during the RTO economic optimization cycle:

$$Profit = {\sum }_{i = 1}^{I} {[ {F}_{p} ( i ) * {P}_{p} ( i ) ]}_{Products} - {\sum }_{j = 1}^{J} {[ {F}_{f} ( j ) * {P}_{f} ( j ) ]}_{Feeds} - {\sum }_{m = 1}^{M} {[ {F}_{u} ( m ) * {P}_{u} ( m ) ]}_{Utilities}$$

where “Profit” is the net profit calculated as the difference of product realizations minus feed costs and minus operating costs (currency/time); “Fₚ(i)” are the flow rates of products produced and “Pₚ(i)” their sales prices (currency/flow rate); “F_{f}(j)” are feed rates processed (flow rate/time) and “P_{f}(j)” their purchasing or replacement costs (currency/flow rate); and “fᵤ(j)” are related utilities costs (flow rate/time) and “Pᵤ(j)” their costs (currency/flow rate). Consistent with the addition of one or more Blending Models to a “downstream” RTO application, the Profit objective function is modified by including additional feed cost terms for intermediate streams from “upstream” units that are routed directly to finished product blending, and that are outside of the optimization scope of the “downstream” RTO application:

$$Profit = {\sum }_{i = 1}^{I} {[ {F}_{p} ( i ) * {P}_{p} ( i ) ]}_{Prod} - {\sum }_{j = 1}^{J} {[ {F}_{f} ( j ) * {P}_{f} ( j ) ]}_{Feeds} - {\sum }_{m = 1}^{M} {[ {F}_{u} ( m ) * {P}_{u} ( m ) ]}_{Util} - {\sum }_{k = 1}^{K} [ {F}_{I} ( k ) * {P}_{Ref} ( k ) ]$$

where “F_{I}(k)” are the flow rates of intermediate streams routed from “upstream” units to finished product blending and “P_{Ref}(k)” are their “Reference” Prices typically supplied by the plant's Planner/Economist. These prices represent the best estimate of the average value of each intermediate stream over a given operating planning period, and can be estimated by a number of means, including use of the marginal valuation obtained from the planners' weekly or monthly off-line linear-planning models. Once the profit objective function is included as described above, the Shadow Prices calculated by RTO for the intermediate stream rates, “Δ P^{F}_{SP}(k,j)”, and quality-barrel, “Δ P^{Q}_{SP}(k,j)”, actually represent the incremental valuation above or below the Reference Price. As described in the next section, the economic objective function of the “upstream” RTO is also modified to be consistent with this incremental Shadow Price valuation relative to the Planner-supplied Reference Prices. This also provides a pricing fall-back mechanism whereby the “upstream” RTO can continue to use the Planner's intermediate stream Reference Price in cases when the “downstream” RTO experiences a prolonged outage, and therefore does not update the Shadow Prices. When all RTOs are running at their normal frequency, though, the Shadow Price valuation represents a real-time incremental adjustment, or fine-tuning, of the Planner-supplied intermediate stream Reference Price.

Quality-Barrel Model

The Quality-Barrel model dynamically calculates the price for each intermediate stream taking into account the effect of rate and quality Shadow Prices calculated by the respective “downstream” RTO applications. The Quality-Barrel model takes as inputs the intermediate stream Reference Price “P_{Ref}(k)” (typically supplied by the Planners, and the same one used in the “downstream” RTO); the intermediate stream quality “q_{I}(k,j)” calculated by the “upstream” RTO; the Shadow Prices for the intermediate stream flow rate and quality, “Δ P^{F}_{SP}(k)” and “Δ P^{Q}_{SP}(k,j)” respectively, calculated by the “downstream” RTO; and a reference quality “Q_{Ref}(k,j)”, which typically is the product specification for the corresponding quality in the finished blend pool. The product price for the “k^{th}” intermediate stream is then calculated by means of the following equation:

$${P}_{p} ( k ) = {P}_{Ref} ( k ) + Δ {P}_{SP}^{F} ( k ) + {\sum }_{j = 1}^{J} φ ( k , j ) * [ {q}_{I} ( k , j ) - {Q}_{Ref} ( k , j ) ] * Δ {P}_{SP}^{Q} ( k , j )$$

where “φ(k, j)” is the blending factor for a given stream and quality. The value of this blending factor is unity (1.0) if the blending rule for the given quality calls for a mass or volume blending basis only, or its value will be determined by the appropriate correlation if the blend rule is to be done on a “factor” basis. The adjusted price “Pₚ(k)” calculated by this equation is input to the profit objective function of the “upstream” RTO application, as already defined above, where it is multiplied times the corresponding intermediate stream flow rate “Fₚ(k)” in the economic product realization expression.

$$Profit = {\sum }_{i = 1}^{I} {[ {F}_{p} ( k ) * {P}_{p} ( k ) ]}_{Products} - {\sum }_{j = 1}^{J} {[ {F}_{f} ( j ) * {P}_{f} ( j ) ]}_{Feeds} - {\sum }_{m = 1}^{M} {[ {F}_{u} ( m ) * {P}_{u} ( m ) ]}_{Utilities}$$

Compositional Economic Valuation of Intermediate Streams

For intermediate streams which are sent to other parts of the plant for further processing (e.g. reactors, distillation, etc.) and not finished product blending, and which cross the optimization scope of two or more RTO applications, the Shadow Pricing methodology is applied to compositional species, rather than to quality-barrel effects. The following modules are added to existing RTO applications to enable the calculation and communication of Shadow Prices for compositional species that characterize each intermediate stream.

Component “Lumper” and “Delumper” Model

The purpose of component lumping or de-lumping is to convert the component slate, or population of compositional species, of a given stream in one RTO application to match the stream component slate definition of another RTO application. This conversion is achieved by reducing, or expanding, the number of components in the given stream to derive a subset, or superset, of stream components, respectively, while retaining the same total mass, and by applying lumping, or de-lumping, rules which aim to retain the physical and chemical properties of the key compositional groups present in the stream (e.g. Paraffin, Aromatics, Olefins, etc.) For every intermediate stream in each “upstream” RTO application a component “Lumper” or “Delumper” Model is added to convert the component slate to the one required as input for the corresponding “downstream” RTO application. In FIG. 3 the “Lumper” 232 in FCCU RTO 230 converts the “FCC” component slate (used in the FCCU RTO model flow sheet) to the “Reformer” component slate (used in the Reformer RTO model flow sheet), so that Shadow Prices calculated by the Reformer RTO 220 for each compositional species in its feed can be directly input as prices for the same compositional species in the profit objective function of the FCCU RTO application.

Compositional Pricing Model

The computational output of the “Lumper” or “Delumper” model is a standard stream including total molar rate (moles/time) and molar concentration (mole percent or fraction) for each species, suitable for connection to another model, as well as a mass rate (mass/time) for each lumped or de-lumped compositional species. To ensure conservation of mass in the lumping or de-lumping process of compositional species, it is these mass rates that are used in the profit objective function of the “upstream” RTO, together with the corresponding compositional Shadow Prices calculated by the “downstream” RTO. The purpose of the Compositional Pricing Model 233, added to the “upstream” RTO 230, is to evaluate the following price calculation for every intermediate stream “k” which is to be valued on a compositional Shadow Pricing basis:

$${P}_{p} ( k ) = {P}_{Ref} ( k ) + \frac{1}{M ( k )} {\sum }_{j = 1}^{J} m ( k , j ) * Δ {P}_{SP}^{C} ( k , j )$$

$$where \text{:} M ( k ) = {\sum }_{j = 1}^{J} m ( k , j )$$

and “P_{Ref}(k)” (currency/mass) is the stream Reference Price (typically supplied by the Planners, and the same one used in the “downstream” RTO); “m(k,j)” is the mass rate (mass/time) of the “j^{th}” compositional species in the “k^{th}” intermediate stream; “M(k)” is the stream total mass rate (mass/time); and “Δ P^{C}_{SP}(k,j)” is the Shadow Price (currency/mass) for the “j^{th}” compositional species in the “k^{th}” intermediate stream calculated by the “downstream” RTO, as described below. The adjusted price “Pₚ(k)” (currency/mass) calculated by this equation is input to the profit objective function of the “upstream” RTO application, as already defined above, where it is multiplied times the corresponding intermediate stream flow rate “Fₚ(k)” (mass/time) in the economic product realization expression.

Intermediate Stream Source Model

For every intermediate stream 233 that crosses the optimization scope of two RTO applications, where its flow and composition are potentially optimized in an “upstream” RTO 230 and then becomes the feed to a process unit optimized in a “downstream” RTO 231 (excluding finished product blending), a Source Model 222 is added to the “downstream” RTO application. One or more Source Models may be required, depending on the number of feed streams processed in the unit. The purpose of the Source Model is to define a consistent set of input conditions for the “downstream” RTO, including component slate composition, flow rate and thermal properties. As part of the integrating mechanism between the two RTO applications, the “upstream” RTO application updates the stream compositional data in the Source Model of the “downstream” RTO every time the former completes its optimization cycle.

Mixer Model

The purpose of the Mixer Model 223 is to mimic the blending of the various feed streams that are routed to the process units optimized by the “downstream” RTO application 220. One or more Mixer Models may be required, depending on the physical configuration of the unit's feed system. The Mixer Model input is the standard stream data definition, including molar flow (moles/time) and composition (mole fraction), as well as key thermodynamic properties for one or more streams from the Source Models. The Mixer Model output is the blended molar flow rate, molar composition and thermodynamic properties.

Analyzer Model

The purpose of the Analyzer model 224 is to convert the blended stream molar flow rate “Fₘₒₗₐᵣ” and molar composition xₘₒₗₐᵣ for the “i^{th}” component and outputs from the Mixer Model 222 to total stream mass rate “Fₘₐₛₛ” (mass/time) and to a weight fraction xₘₐₛₛ(i) The following formulae can be used to achieve this conversion:

$${f}_{mass} ( i ) = {x}_{molar} ( i ) * mw ( i ) * {F}_{molar}$$

$${F}_{mass} = {\sum }_{i = 1}^{I} {f}_{mass} ( i )$$

$${x}_{mass} ( i ) = {f}_{mass} ( i ) / {F}_{mass}$$

where “fₘₐₛₛ(i)” is the “i^{th}” component mass rate.

Compositional Blending Model

The purpose of this model is to generate the Shadow Price for each compositional species by using an adjustment technique similar to the Quality-Barrel valuation approach described above. In order to enable the “downstream” RTO application to calculate and then communicate to other “upstream” RTOs, the marginal economic value of each compositional species in the intermediate stream fed to the process units in its optimization scope, an additional variable “A_{C}(i)” is introduced to the feed mass balance equations, as follows:

$${f}_{mass}^{A} ( i ) = {f}_{mass} ( i ) + {A}_{C} ( i )$$

$${F}_{mass}^{A} = {\sum }_{i = 1}^{I} {f}_{mass}^{A} ( i )$$

$${x}_{mass}^{A} ( i ) = {f}_{mass}^{A} ( i ) / {F}_{mass}^{A}$$

where variable “fₘₐₛₛ(i)” is the resulting output from the Analyzer Model, and variables superscripted with the letter “A” are the corresponding “adjusted” variables output by the Analyzer Model. Variable “A_{C}(i)” in this equation represents an independent mass rate adjustment for each compositional species “i” in the feed stream of the process unit optimized by the “downstream” RTO application. The value of each “A_{C}(i)” in the Compositional Blending Model is set equal to zero such that it does not influence the result of the mass balance calculation. However, because each “A_{C}(i)” is an independent variable, a Shadow Price “Δ P^{C}_{SP}(i)” is generated for it during every economic optimization cycle of the “downstream” RTO application. This Shadow Price represents the incremental credit or debit for adding a unit mass rate of each compositional species to the unit feed stream, in dimensions of (currency/time)/(mass/time).

The Shadow Prices for all “A_{C}(i)” determined in this manner are subsequently communicated to the “upstream” RTO applications. These applications optimize the flow rates and compositions of the intermediate streams. Consistent with this, the economic objective functions of the “upstream” RTOs are formulated to directly include, as an economic drive, the Shadow Prices for the mass flow rates for each compositional species. This is described above under the heading of the Compositional Pricing Model. Similarly, the economic objective function of the “downstream” RTO application is also modified, to effect a systematic and consistent communication of the Shadow Prices between “downstream” and “upstream” RTOs. The following modifications are made to the objective function of the “downstream” RTOs. An example of a Profit objective function that is maximized during the RTO economic optimization cycle was given above under Quality Blending Model. This objective function is modified to add the feed cost term for the intermediate streams, represented by the last term in the equation:

$$Profit = {\sum }_{i = 1}^{I} {[ {F}_{p} ( i ) * {P}_{p} ( i ) ]}_{Prod} - {\sum }_{j = 1}^{J} {[ {F}_{f} ( j ) * {P}_{f} ( j ) ]}_{Feeds} - {\sum }_{m = 1}^{M} {[ {F}_{u} ( m ) * {P}_{u} ( m ) ]}_{Util} - {\sum }_{k = 1}^{K} [ {F}_{I} ( k ) * {P}_{Ref} ( k ) ]$$

where “F_{I}(k)” are the flow rates of intermediate streams sent from “upstream” units to “downstream” units for further processing, and “P_{Ref}(k)” are their “Reference” Prices typically supplied by the plant's Planner/Economist. As already described above, these Reference Prices represent the best estimate of the average value of each intermediate stream over a given operating planning period, and can be estimated by a number of means, including use of the marginal valuation obtained from the planners' weekly or monthly off-line linear-planning models. Because reference pricing for intermediate streams is included in the Profit objective function as shown, the Shadow Prices calculated by the “downstream” RTO for each compositional species, “Δ P^{C}_{SP}(k,j)”, actually represent the incremental valuation above or below the Reference Price.

Total Feed Source Model

The purpose of the Total Feed Source Model 226 is to convert the total mass rate and component weight fractions back to the standard stream data format of molar rate, mole fraction compositions, and consistent thermodynamic properties, so the feed stream can then be connected to the remaining RTO models.

Transfer of Shadow Prices and Stream Data Between RTOs

Any number of already available means can be employed to transfer data relating to intermediate stream Shadow Prices and composition data between controllers and/or RTO applications. The data may be stored in a database which is accessed by the controllers.

Validation and Fallback Mechanisms

Shadow Prices calculated by “downstream” RTO applications are validated before being sent to the “upstream” RTO, by comparing the Shadow Price values to maximum low and high limits, and clipping them if they exceed these validity limits. The introduction of “Reference Prices” for intermediate streams also provides a pricing fall-back mechanism whereby the “upstream” RTO can continue to use the Planner's intermediate stream Reference Price in cases when the “downstream” RTO experiences a prolonged outage, and therefore does not update the Shadow Prices. When all RTOs are running at their normal frequency, though, the Shadow Price valuation represents a real-time incremental adjustment, or fine-tuning, of the Planner-supplied intermediate stream Reference Price.

According to another embodiment of the invention there is provided a computer program for conducting the method steps as defined and as hereinbefore described to control a multistage process for producing an end product as hereinbefore described.

Any of the above described models, either alone or in combination, may be used to assign values to the intermediate and/or further processes. The models may also be used, either alone or in combination, to define or calculate properties which are associated with the intermediate and further processes and/or products.

The present invention may be implemented as a real time optimizer unit, comprising an intermediate controller IC for controlling the first stage process in response to one or more product properties of said end product EP; and a further controller FC for controlling the further stage process in response to the product properties of the intermediate product IP, wherein each of the processes E_{1 . . . n} and each of the processes I_{1 . . . n} have assigned process values VE_{1 . . . n} and VI_{1 . . . n}; and the intermediate controller controls the intermediate processes I_{1 . . . n} to optimize the overall process value derived from process values for the intermediate product VI_{1 . . . n} and the end product VE_{1 . . . n} to produce the end product.

In a further embodiment, the invention is implemented on a machine such as a computing apparatus. The program or software in which the method as herein before described has been implemented may be stored on the computing apparatus by any storage medium including, but not limited to, recording tape, magnetic disks, compact disks and DVDs. Some portions of the detailed description herein are consequently presented in terms of a software implemented process involving symbolic representations of operations on data bits within a memory or a computing system or a computing device. These descriptions and representations are the means used by those in the art to effectively convey the substance of their work to others skilled in the art. The process and operation require physical manipulations of physical quantities. Usually, though not necessarily these quantities take the form of electrical, magnetic, or optical signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these terms are to be associated with the appropriate physical quantities and are merely convenient labels applied to these quantities. Unless specifically stated or as otherwise may be apparent, throughout the present disclosure, these descriptions refer to actions and processes of an electronic device, that manipulates and transforms data represented as physical (electronical or magnetic or optical) quantities within some electronic device storage into other data similarly represented as physical quantities within the storage, or in transmission of display devices. Exemplary of the terms in this description are without limitation the terms processing, computing, calculating, determining and displaying.

The software implemented aspects of the invention are typically encoded on some form of program storage medium or implemented via some type of transmission medium. The program storage medium may be magnetic (for example a floppy disk or hardrive) or optical (a compact disk read only memory, or DVD), and may be read only or random access. Similarly the transmission medium may be twisted cable, optical fibers or some other suitable transmission medium known in the art. The invention is not limited by these aspects of any given implementation.

There is thus provided a method of controlling a multi-stage process, and an apparatus for controlling the process. The invention has the important advantage that it allows real time control of the process taking into account real time external economic data. This allows the process to operate in response to real time market conditions for feed streams, end products and intermediate products and feed streams.

It should be appreciated by those skilled in the art that the concepts and specific embodiments disclosed herein may be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A method of controlling a multi-stage process, the process comprising
a) providing one or more first stage processes for producing an intermediate product IP from a feed F, wherein the first stage processes comprise multiple intermediate processes I_{1 . . . n} for producing the intermediate product IP;
b) providing one or more further stage processes for producing an end-product EP from the intermediate product IP, wherein the further stage processes comprise multiple end processes E_{1 . . . n} for producing the end-product EP;
e) providing an intermediate controller IC for controlling the first stage processes in response to one or more product properties of said end product EP;
f) providing a further controller FC for controlling the further stage processes in response to the product properties of the intermediate product IP;
g) assigning process values VE_{1 . . . n} , to each of the end processes E_{1 . . . n} and process values VI_{1 . . . n} to each of the intermediate processes I_{1 . . . n}; and
h) controlling, with the intermediate controller IC, operation of the intermediate processes Iᵢ with i=1 . . . n to optimize the overall process value VE for producing the end product EP.

2. The method of claim 1, wherein the further controller FC controls operation of the end processes Eᵢ with i=1 . . . n to optimize the overall process value VI for producing the intermediate product IP.

3. The method of claim 1, wherein the controller selects a process Iᵢ or Eᵢ with i=1 . . . n for activation to optimize the overall process value VE for producing the end product EP.

4. The method of claim 1, wherein the overall process value is optimized by defining an objective function for the overall process value and optimizing said function, said controllers controlling the respective processes Iᵢ and Eᵢ in response thereto.

5. The method of claim 1, wherein the overall process value VI is optimized by defining an objective function for the overall process value VI and optimizing said function, the further controller FC controlling the end processes Eᵢ in response thereto.

6. The method of claim 1, wherein the overall process value VE is optimized by defining an objective function for the overall process value VE and optimizing said function, the intermediate controller IC controlling the intermediate processes Iᵢ in response thereto.

7. The method of claim 1, wherein each of said intermediate processes I_{1 . . . n} produces the same intermediate product IP

8. The method of claim 1, wherein each of said end processes E_{1 . . . n} produces the same end product EP.

9. The method of claim 1, wherein the intermediate controller transfers data relating to the intermediate processes Iᵢ to the further controller FC.

10. The method of claim 1, wherein the further controller transfers data relating to the further process Eᵢ to the intermediate controller IC.

11. The method of claim 1, wherein the product properties comprise physical properties and economic values of the product, the respective controllers controlling the intermediate processes IP and the end processes EP in response thereto.

12. The method of claim 1, wherein the economic values are derived from shadow prices.

13. The method of claim 1, wherein the process values are derived from process operating parameters and/or product properties such as composition, quantity, price, and physical properties.

14. The method of claim 1, wherein the process values VE_{1 . . . n} and VI_{1 . . . n} are derived by a model comprising a quality blending model, a quality barrel model, a component lumper model, a component delumper model, a compositional pricing model, an intermediate stream source model, a mixer model, an analyzer model, a compositional blending model, a total feed source model and/or combinations of the aforesaid models.

15. The method of claim 1, wherein the process values VI_{1 . . . n} and VE_{1 . . . n} are derived from the respective process values VE_{1 . . . n} and VI_{1 . . . n}.

16. The method of claim 1 wherein the process is controlled in real time.

17. A real time optimization system (RTO) adapted to perform the method as defined in claim 1.

18. An apparatus for controlling a multi-stage process for producing an end-product EP, wherein said multi-stage process comprises i) one or more first stage processes for producing an intermediate product IP from a feed F, wherein the first stage processes comprises multiple intermediate processes I_{1 . . . n} for producing the intermediate product IP and ii) one or more further stage processes for producing an end-product EP from the intermediate product IP, wherein the further stage processes comprise multiple end processes E_{1 . . . n} for producing the end product EP, wherein the apparatus comprises the following components:
(a) an intermediate controller IC for controlling the first stage process in response to one or more product properties of said end product EP;
(b) a further controller FC for controlling the further stage process in response to the product properties of the intermediate product IP; and
(c) a means for assigning process values VE_{1 . . . n} to each of the processes E_{1 . . . n} and process values VI_{1 . . . n} to each of the intermediate processes I_{1 . . . n},
wherein the intermediate controller IC is adapted to control the intermediate processes I_{1 . . . n} to optimize the overall process value derived from process values for the intermediate product VI_{1 . . . n} and the end product EI_{1 . . . n} to produce the end product.

19. The apparatus of claim 18, wherein the apparatus comprises a computer based intermediate controller and a computer based further controller.

20. The apparatus of claim 18, wherein the apparatus comprises a computer based optimizer for optimizing an objective function, said objective function comprising control parameters corresponding to the intermediate process I, end process E, intermediate product IP and end product EP, said optimizer calculating the optimized objective function, said controllers controlling the respective processes Iᵢ and Eᵢ in response to the control parameters corresponding to the optimized objective function.

21. A program storage device readable by a machine embodying a program of instructions executable by the machine to perform the method steps of claim 1.
